(19) United States
(12) Patent Application Publication
(10) Pub. No.: US 2012/0325901 A1
(43) Pub. Date: Dec. 27, 2012

(54) Method for turning printed books into interactive printed books by using custom software to create and insert barcode-indicia that link readers to remote websites

(76) Inventor: Lynn Manning Ross, San Diego, CA (US)

(21) Appl. No.: 13/134,988

(22) Filed: Jun. 23, 2011

(51) Int. Cl. G06F 17/00; G06K 19/06

(52) U.S. Cl. 235/375; 235/494

(57) ABSTRACT

This is a method for custom designed software that adds educational value to any printed book past, present and future before it is printed, re-printed or reissued. Database driven, the author or editor (user) answers manuscript-related questions resulting in the selection of contextual keywords throughout the book's manuscript. Merging the user's answers with selected keywords determines the identification of compatible informational content. Once a match has been made and content providers selected, a customized-redirect two-dimensional (2D) barcode is generated. These barcode-indicia are returned to users for insertion into the manuscript prior to printing the book. The software also stores, updates and tracks all database entries, the 2D barcodes, and maintains, manages, collects and disburses funds to all participating alliances in a given transaction.

### BACKGROUND OF THE INVENTION

1. Field of the Invention

The present invention relates to a method of using custom-redirect two dimensional barcode technologies to link electronic content to a printed book publication and make the electronic content easily accessible to a reader.

2. Background Information

Two-dimensional (2D) barcodes, better known as Quick Response (QR) Codes, were created in 1994 by the global conglomerate Denso-Wave, a Japanese corporation, as an inventory control system and approved as an ISO International Standard (ISO/IEC18004) in June 2000. The company patented their QR Code and then released their patent to the Creative Commons. Unlike conventional one dimensional barcodes which only store up to 20 characters, the two dimensional barcode will store up to 7,089 numeric and alphabetic characters, symbols, binary, and control codes. Because of the codes' accuracy, reading speed, and superior functionality, they have been used by advertisers throughout Asia for over a decade.

Advertisers, predominantly in Asia, print the 2D barcodes on billboards, on advertisements in magazines, newspapers, trade journals, menus, stickers, business or greeting cards, price tags, placards, product and display tags, and on other types of disposable printed media. The idea is to motivate the consumer who reads the advertisement to click on the 2D barcode using their Web enabled mobile phone with a camera, also known as a smartphone. This activates a smartphone application that has the capacity to read the 2D barcode and instantly link the user to the advertiser's website. Viewed on their smartphone, users then watch the requested information or browse the advertiser's website for other available options, such as, discount coupons, maps and the like. And if customers opt to do so, they may download what they want onto their smartphones.

Of particular importance here is the practice of displaying the 2D barcodes on disposable print media, which has a short shelf life. By utilizing disposable print media, advertisers can frequently change the 2D barcode's configuration. Once changed, the new reconfigured 2D barcode is then placed in new advertisements and other disposable print media that links the interested consumer to new webpages.

Printed books, however, are very different. Each has a long shelf life tied to the book's print run cycles that is to say, the “first print run” may be for 2,500 books. It might take a year to sell all of them before a publisher will initiate the second print run and so on. But despite the number of print runs, and unlike disposable media, a book from the first print run will not be tossed. A book from the first print run will be sitting on someone's bookshelf including a library's shelf.

Two-dimensional barcodes have been utilized as instant links to products and services on websites hosted in remote locations for some time, such as, the claims in U.S. Pat. No. 6,708,208. In addition, barcode technology has been used to access remote computers, as described in U.S. Pat. No. 6,760,884. The 2D code technology presents an opportunity to generate custom-redirect 2D codes that assure readers and informational content providers of current information despite a book's long shelf life.

### SUMMARY OF THE INVENTION

This invention is not the first application to use 2D barcodes to access Internet websites. The present invention organizes photographs with the use of a specific barcode associated with each photograph on a website. It is important to note, however, that the present software invention is not about whether a barcode can be scanned and link users to remote websites. The present software invention is about opening new marketing channels for printed books and giving readers an option to learn more without leaving the printed page using the custom-redirect 2D barcode printed on a book's page.

### BRIEF DESCRIPTION OF THE DRAWINGS

FIG. 1 is a diagram illustrating aspects of the method of the present invention.

FIG. 2 is a diagram illustrating aspects of the method of the present invention.

FIG. 3 is a diagram illustrating aspects of the method of the present invention.

FIG. 4 is a diagram illustrating aspects of the method of the present invention.

FIG. 5 is a an illustration displaying potential inputs for determine pertinent data used for the present invention illustrating

FIG. 6 is a diagram illustrating aspects of the method of the present invention.

FIG. 7 is a table of book genres.

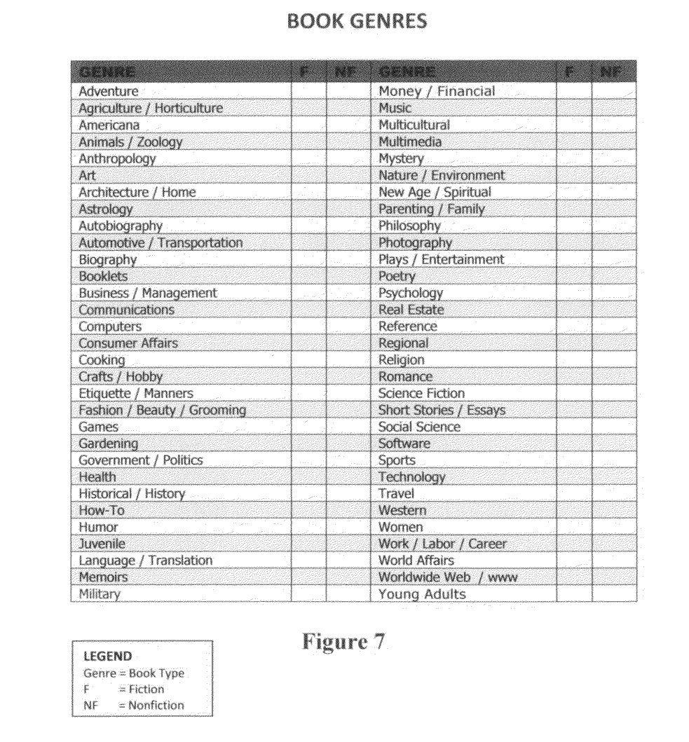

FIG. 8 is a diagram illustration displaying potential inputs for determine pertinent data used for the present invention illustrating

### DETAILED DESCRIPTION

The present invention is illustrated by way of example and not by way of limitation in the figures of the accompanying drawings. The inventions are not limited to the referenced embodiments in this disclosure. While specific implementations are discussed, it is understood that this is done for illustrative purposes only. A person skilled in the relevant art will recognize that other components and configurations may be used without departing from the scope and spirit of the invention. It will be apparent to those skilled in the art that the invention may be practiced using any similar type of component(s) used in the illustrations. In other instances, well-known features have not been described in detail so as not to obscure the invention. Although a diagram may depict components as logically separate, such depiction is merely for illustrative purposes. It will be apparent to those skilled in the art that the components portrayed can be combined or divided into separate software, firmware, and/or hardware components.

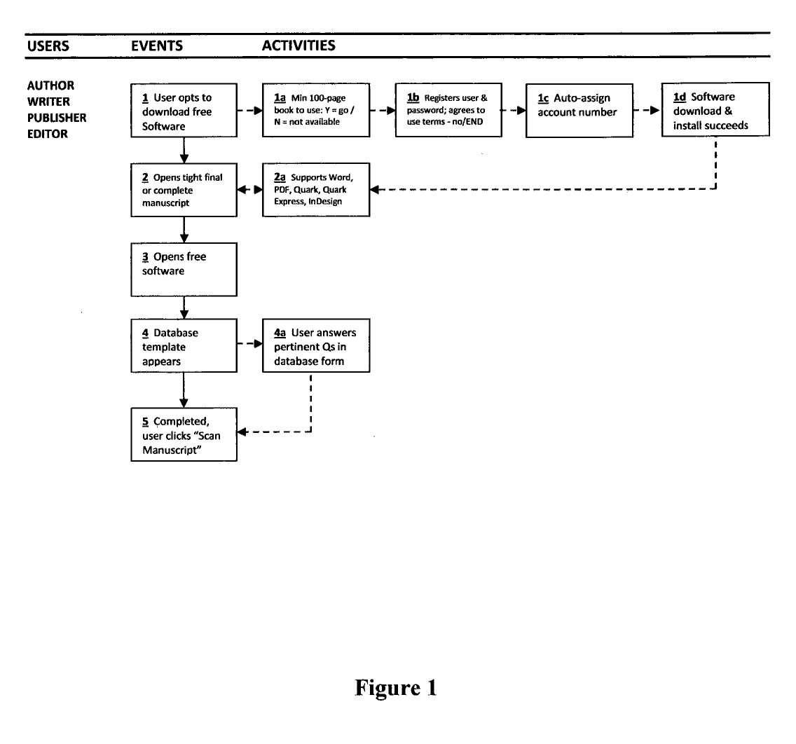

FIG. 1 is a block diagram illustrating an exemplary embodiment of the present invention. FIG. 1 is the first stage of a method of the present invention. In FIG. 1, a first time user opts to download free software 1. A user uses the software on an electronic computing device, which includes but is not limited to mobile phones, personal computers, tablet computers and netbooks. Users include authors, writers, publishers, editors, book packagers, ghost writers, literary agents and like users. The software may be provided to a user free of charge or for charge.

For software download, there may be a requirement that a book be at least 100 pages in length 1a. After meeting the page requirement 1a, the username and a password are registered with the software provider and the user selects whether to agree with a licensing agreement 1b. If the user selects to not agree with the licensing agreement, the user cannot download the software. Upon agreeing to the terms of use, the user is automatically assigned a unique identifier (ID) 1c. Next, the software is automatically downloaded and installed on an electronic computing device.

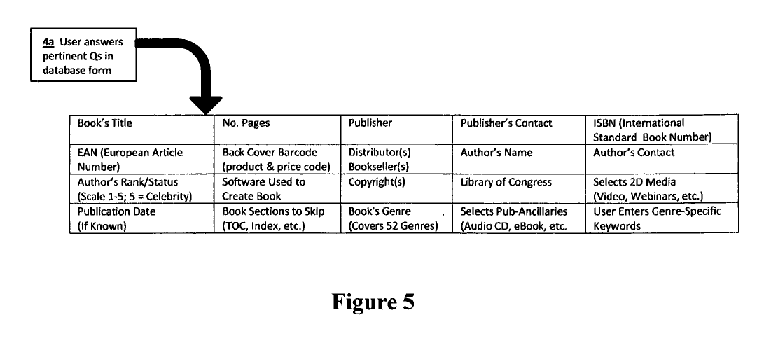

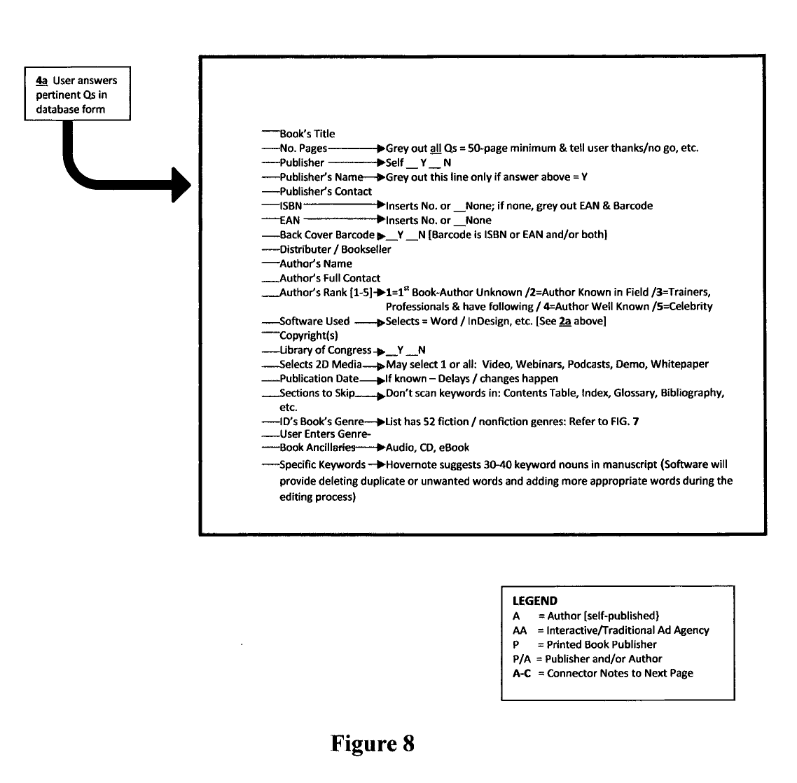

Next, the user opens a tight final of a new manuscript that the user originated or a completed manuscript that is considered part of a publisher's existing frontlist, backlist, archived, republished, out-of-print or is a part of the public domain 2. The Publisher-enhanced software recognizes and supports the following book publishing software: Quark, Quark Express, InDesign, PDF, Microsoft Word (three versions thereof) and XML 2a. After opening a manuscript 2, the user opens the Publisher-enhanced software and the software populates a template 3. The user enters pertinent data relating to the manuscript 4. Preferred pertinent data is shown in FIG. 5 and FIG. 8.

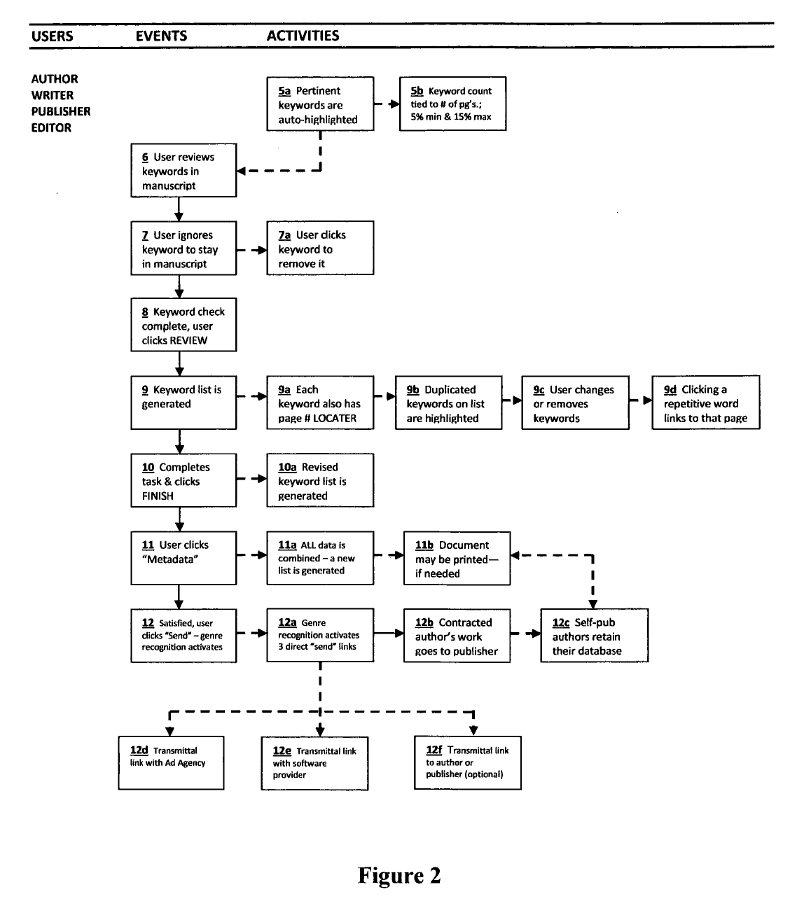

FIG. 2 is a block diagram illustrating an exemplary embodiment of the present invention. FIG. 2 is the second stage of a method of the present invention. After entering the pertinent data 4, the user selects to scan the document 5. The scan of the document 5 highlights pertinent keywords throughout the manuscript 5a. The number of keywords may be subject to a minimum or maximum number that corresponds to a manuscript's page count 5b. In one preferred embodiment, the number of keywords is limited to 5% minimum and 15% maximum of the in a manuscript. The user reviews the highlighted pertinent keywords in the manuscript 6. If a user does not indicate to un-highlight a highlighted pertinent keyword, that keyword is ignored it stays in the book 7. If a user desires to remove a word from being designated as a pertinent keyword, the user is given an opportunity to do so. For example, if a “pertinent keyword” is double clicked, the highlight is removed but the word remains in the text.

After the user reviews the text of the manuscript 8, a list of the pertinent keywords generated 9. The generated list may also include the page number in the manuscript where the pertinent keywords are located 9a and visually indicate the duplicated pertinent keywords 9b. The generated list of pertinent keywords provides the user with an opportunity to modify the pertinent keywords 9c. For example, it is not sufficient to repeat the word “museum” many times or to write generic descriptions such as a “Paris museum;” the user needs to provide a specific description, e.g. the “Louvre” museum. Providing the user with an opportunity to modify the keywords 9c allows the user to micro-manage the pertinent keywords with specific instructions when needed while maintaining the page number and integrity of the database. The database includes keywords a user selects and then matches these keywords to educational content provided by content providers. One such example of educational content is webinars, videos, podcasts, and whitepapers that help readers learn more about what the author is saying. Tagging means, when the user selects the keywords in a manuscript, the “word” is highlighted. When the user makes a modification, the specific keywords are updated and retagged. If the user opts to leave the text as the text maintains its original meaning and appearance.

When a user selects a repetitive keyword on the list, the page where the repetitive word is located is populated and the user can then remove the pertinent keyword 9d, in a manner the same or similar as steps 7a and 9c. When the user is done reviewing the pertinent keywords, the user inputs into the software that the user is finished with the review 10. Next, a revised list of the pertinent keywords generated 10a. If the user desires to modify the revised list, the user may review the list again 6. Once the user is satisfied with the list, user clicks “Metadata” 11. Metadata means different pieces of information that are brought together as a complement one to the other to form a cohesive whole. A final description of all revised metadata that has been entered, plus the list of “tags,” is generated 11a. Record of metadata may be physically printed 11b.

If the user is satisfied with the metadata, the user selects to send the metadata to all participating partners 12. Upon selecting to send the metadata, a genre recognition is activated 12a, using data input by the user in step 4a and then the transmittal links are activated. In a preferred embodiment, a transmittal link includes Interactive (digital) Ad Agencies and/or traditional Ad Agencies specializing in the user's specific genre, and a transmittal link to the software provider. A third transmittal link to the self-published author, if other than a publisher which is optional and subject to the user's choice. Ad agencies may include both interactive and traditional ad agencies and one or the other. Metadata is sent to a publisher if an author is under contract to the publisher 12b. Self-published authors may retain their own databases since they are the ones who activated transmittal link(s) and already have the manuscript 12c.

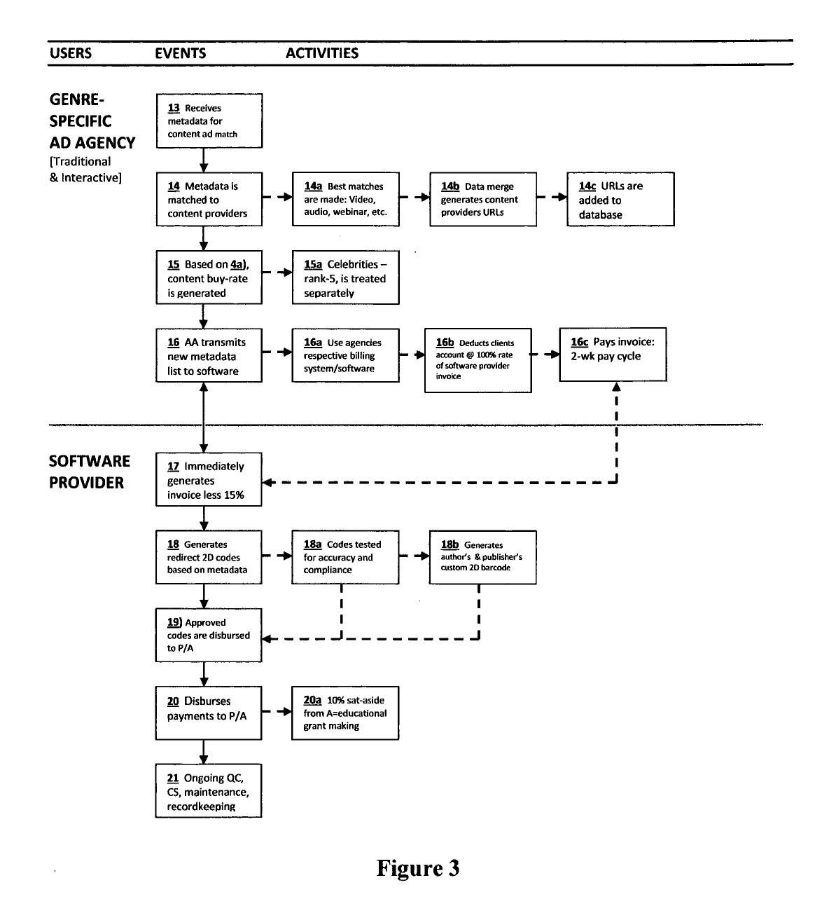

FIG. 3 is a block diagram illustrating an exemplary embodiment of the present invention. In FIG. 3, a method for at least one ad agency and a software provider is illustrated. After a user sends metadata to an ad agency 12a, the ad agency receives the metadata and can match the keyword(s) to their educational content providers 13. The status and genre of a publisher/author and genre selected in step 4a and keywords influences an ad agency's selection of “educational content” for the database merge. The database contains keywords from one title. The user (author) has determined a reader “might” want an explanation, e.g., the text might read “. . . pro forma . . . ”—pro forma being the keyword. The ad agency, who is also using the software, merges the keyword content with one of their client's that has a video explaining what a pro form is. This is the “database merge” whereby a content provider's media with the appropriate URL is merged with the keyword “pro forma.” In a preferred embodiment, the following is used to also influence the buy-rate a content providers pays annually for the custom-redirect 2D barcode insertion. A buy-rate means how much each custom-redirect 2D barcode insertion costs per year.

Next, at least one ad agency merges the pertinent keywords from the manuscript's list with the ad agencies database of keywords 14. Best matches are determined 14a, and may include webinars, videos, podcasts and/or whitepapers, as indicated in the metadata in the database 4a. The merging of data generates at least one complete Uniform Resource Locator (URL) (or other electronic address, linking and/or directing means) for each content provider 14b. The URL is added to the ad agency's keyword and metadata database 14c. Using information from 4a, an estimated gross ad-buy revenue is automatically generated for a manuscript based on the publisher's/authors' self-proclaimed status celebrity status 15. Celebrity or high profile authors may be excluded from the automatically generated ad-buy revenue calculation 15a.

The ad agency then disseminates a revised “pertinent metadata and keyword list” to the software provider 16. Ad agencies may bill advertisers using their respective internal billing procedures/systems 16a. Once an ad agency determines which content provider complements a keyword, the ad agency deducts the cost for the custom-redirect 2D barcode insertion in the printed book and deducts that amount from the content providers account.

Deducts content providers' accounts @ 100% ad buy rate (assumed procedure) 16b; whereby the ad agency will be required to pay the software provider's invoice in a designated billing cycle.

From the ad agency transmission 16, the software provider generates an invoice 17 and electronically transmits the invoice to the ad agency for payment 16c. Based on pertinent metadata and keyword list from the ad agency, a custom-redirect 2D barcode is generated for the respective publishers and/or authors. Codes may be tested for accuracy and compliance with industry standards and/or a software provider's standards for informational content 18a. Content providers may use logos to identify their educational content on their respective websites featuring the educational videos, webinars, podcasts, mock-up demonstrations or whitepapers. Once the software provider has approved the custom-redirect 2D barcode for accuracy, codes are generated for the author's /publisher's manuscript insertion 18b and transmitted with the pertinent metadata and keyword list to the publisher and/or author 19.

Next, the software provider disburses payment to publisher and/or author. The payment disbursements to publishers and authors may be different amounts 20. For example, self-publishers are generally paid less than traditional publishers. Furthermore, designated amounts may be separated for educational grant activities 20a. In addition, ongoing maintenance of databases, upgrading, quality control and customer services are the responsibility of the software provider 21. Although step 21 is shown at the end of this method, this step may occur during any or all of the previous steps as well as after subsequent steps.

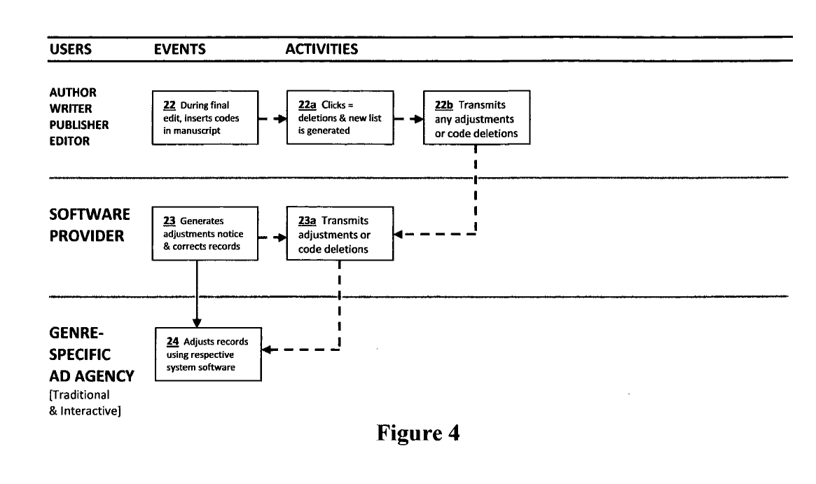

FIG. 4 is a block diagram illustrating an exemplary embodiment of the present invention. During a final edit of a manuscript, a user inserts the custom-redirect 2D barcode rcodes in the manuscript during its final edit according to prior the merged “pertinent metadata” before book goes to print 22. Generally, manuscripts are edited between 2-6 times before the book is printed. A “final edit” of a manuscript means just that—the last edit before the book is sent to a printer. The user may make modifications, including rejections where a 2D code or a word is removed and then a user's internal records are adjusted 22a. A transmission of any user modifications is sent to the software provider 22b.

From the user's notification of his or her modifications 22a, the software provider's database is modified to correspond to the user's changes 23. The software provider transmits a final pertinent keyword list that was merged with metadata to the participating ad agency 23a. The ad agency adjusts its records using the information provided by the software provider and updates its internal recordkeeping system(s).

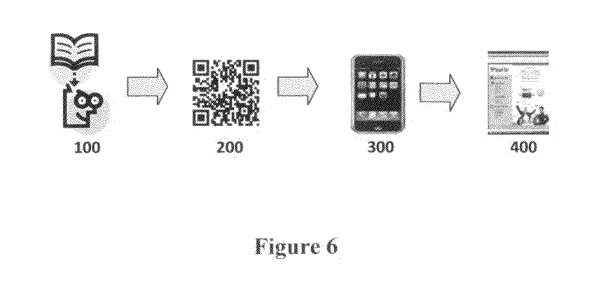

FIG. 6 is an illustration of a method according to the present invention. As illustrated, a reader 100 with an electronic device 300 scans a custom-redirect 2D barcode in the printed book's page 200. This activates a link to pre-determined content 400. The following is an embodiment. When the reader wants to explore more details than the author provides in the text. A custom-redirect 2D barcode complements the author's narrative. Using a Web enabled smartphone with a camera, the reader scans the barcode. Without leaving the printed page, the smartphone links the reader to a free website to “learn more.” With the printed book in one hand and a smartphone in the other, the reader now watches a video, a webinar, demonstration, listens to a podcast or reviews a whitepaper on his or her smartphone. Another reader may opt to repeat the same process but for another clarification in the same book and with the same result as described in 4.

The present invention includes a method for turning a hardcover, soft cover, or trade paperback printed book into an interactive printed book. This is accomplished by using software that authors, writers, publishers and editors (users) can utilize in conjunction with their current publishing software. This provides a reader with a quick and seamless option for learning more about a specific narrative the author/writer is presenting in his or her book. One of the steps is to generate a customized-redirect 2 dimensional barcode (2D code) and test it for accuracy. Once tested and approved, the custom-redirect 2D barcode is transmitted to the user who then places the code by and/or in close proximity to the pre-selected keyword within the text on a printed book page before it goes to print. Once in printed book form, users have the option of using a smartphone to scan the 2D code which will link them to a remote computer, database, or other electronic content source.

In one embodiment, a document may be a hardcover, soft cover or trade paperback printed book whereby the author, writer, publisher or editor (user) has downloaded the publishing enhanced software, agreed to its licensing terms, registered with the software provier, and uses the FREE software to accomplish user objectives for their books.

In one embodiment, the word document may include yet-to-be-identified future printed book titles, current print titles published or not, backlists of print titles previously published, archived and out-of-print titles, and public domain print titles, and whose users have downloaded the publishing enhanced software, agreed to its licensing terms, registered with the software provider, and use the software to accomplish user objectives for their books during their processes of updating, reissuing and/or scheduling new print runs.

In another embodiment, the publisher enhanced software incorporates, but is not limited to, originating and disseminating free software to the printed book industry whether it is used for yet-to-be-identified future printed book titles, current print titles published or not, backlists of print titles previously published, archived and out-of-print titles, and public domain print titles, and whose users utilize the publishing enhanced software during their processes of updating, reissuing and/or scheduling new print runs. The term published enhanced software is meant to describe all of the software's functions—from the time it is first downloaded and used through the function of generating custom-redirect 2 dimensional barcode-indicia (2D codes) and managing all of the operational processes related to the software's functions. Embodiments include that each custom-redirect 2D barcode is an end process that originally began with a user originating a keyword list based upon the book's genre and by selecting the keywords within the book or manuscript that he or she wants amplified. Each custom-redirect 2D barcode (custom-redirect 2 dimensional barcode-indicia) is generated as a one of a kind custom-redirect 2D barcode-indicia and displayed beside the author's text and/or on the page where the author's text so designates.

Once keyword lists are complete and submitted to the software provider, they are transmitted to selected advertising agencies where a genre-specific ad agency coalesces the keyword list with their complementary informational content providers' multimedia which is hosted on remote computers by their respective informational content owners. When scanned, the custom-redirect 2D barcode permits a smartphone barcode-reader application to collect the unique data bits printed on the book's page which are displayed as a custom-redirect 2D barcodes and by collects it means that each technology recognizes the other's data bits as a uniform resource locator (URL); whereupon, the book's reader (enduser) is seamlessly linked to the requested content.

The uniform resource locator (URL) links to value-added information located on the requested remote website and includes, but is not limited to any one of the following: a video, webinar, podcast, computer enhanced demonstration, pictorial demonstration, and/or a whitepaper. Advertising agencies partnering with the software provider and using its software, are in a knowledgeable position to determine the appropriate multimedia complement from among their clients (advertisers) and select complementary multimedia visuals or audios such as videos, webinars, podcasts, computer enhanced demonstrations, pictorial demonstrations, and whitepapers. Pertinent keywords are transformed into pertinent metadata that automatically generates uniform resource locaters (URLs) when merged with the ad agency(ies) content providers' multimedia and returned to software provider where they are transformed into custom-redirect 2D codes.

In another embodiment, once the URL links are added, thereby becoming part of the merged pertinent metadata, the URL links are transmitted back to the software provider. The URL is added to the original merged pertinent metadata and utilized by an ad agency for billing their client(s) for the ad-buy at the prevailing buy-rate. The gross ad-buy revenue is automatically generated for a book based on the publishers/authors' self-proclaimed author's status. This status is contained in the software providers's database from the onset after authors/editors complete their registration and although subject to change, an author's status is based on a scale from 1 (one) to 5 (five). Excluding celebrity authors, ranked as a 5, custom-redirect 2D code insertions (ad-buys) are valued (and will continued to be valued) at the prevailing market rate which, when leveraged for inflation, will vary annually. When an ad agency simultaneously disseminates a revised “pertinent metadata and keyword list” to the software provider, the ad agency(ies) also bills the advertisers' accounts using the ad agency(ies) internal billing procedures and systems.

In some embodiments, this software invention assumes ad agency billing procedures deduct the advertiser's accounts at 100% (one hundred percent) for all ad-buy rates. In addition, invoices may be automatically invoiced to ad agencies based upon the pertinent metadata it receives in 2-week billing cycles. Furthermore, the software provider's invoice has automatically deducted the ad agencies 15% commission from the 100% ad-buy rate the ad agency has received.

In another embodiment, this software invention contains management and operational processes for invoicing, tracking, and payments keyed to the pertinent metadata. Some blatant advertising may disallowed and content providers may use clickable logos to identify their content.

In one embodiment, after the custom-redirect 2D codes have passed the software provider's accuracy and compliance tests, individual barcode indicia are generated and transmitted together with the pertinent metadata and the original keyword list to the publishers, editors, writers and/or authors (users). The users insert the custom-redirect 2D barcodes in the manuscript during the final edit accordingly and prior to the book going to print. Users may also make final adjustments to their original keyword selections by clicking on the custom-redirect 2D barcode or word. When users double-click the keyword it is highlighted as the rejected keyword and all internal records are automatically adjusted. User-adjustments, for any one title, are batched together and transmitted to the software provider. Therefore, the software provider automatically corrects its internal recordkeeping system and adjustment notices are transmitted to the respective ad agency.

### EXAMPLE OF A PREFERRED EMBODIMENT

The following is an example of a preferred embodiment and is not meant as the sole embodiment of this disclosure. To begin, a first time user downloads the free publisher enhanced software 1. In order for the user to download the software, the user must have a book that is at least 100 pages in length 1a. Before the download, the user must register with the software provider 1b. Registration consists of registering a username and a password and agreeing to the software license agreement. The user is automatically assigned a unique ID 1d and then the download of the software begins 1c.

The user opens a tight final of a new manuscript that the user originated or a completed manuscript that is considered part of a publisher's existing frontlist, backlist, archived, republished, out-of-print or is a part of the public domain 2. The publisher enhanced software recognizes and supports the following book publishing software: Quark, Quark Express, InDesign, PDF, Microsoft Word (three versions thereof) and XML 2a. The user opens the publisher enhanced software program and a template appears 3. Then, the user enters pertinent data 4 that includes the following: book's title, number of pages, publisher, publisher's contact information, ISBN (International Standard Book Number), European Article Number, Back Cover Barcode (product & price code), Distributor(s), Bookseller(s), author's name, author's contact information, Author's Rank/Status, Software Used to Create Book, Copyright(s), Library of Congress, Publication Date (If Known), Selects 2D Media (Video, Webinars, etc.), Book's Genre, (Covers 52 Genres), Selects Pub-Ancillaries (Audio CD, eBook, etc.), User Enters Genre-Specific Keywords, and Book Sections to Skip (TOC, Index, etc.). When the form is completed, user clicks “scan manuscript” 5. Pertinent keywords entered in 4 are highlighted throughout manuscript accordingly. Keyword min/max is tied to book's interior page count and is limited to 5% minimum and 15% maximum 5b.

User reviews highlighted “pertinent keywords” in the manuscript 6. If a “pertinent keyword” is ignored it stays in the book 7. If a “pertinent keyword” is double-clicked, the highlight is removed but the word remains in the text 7a. User clicks “review” when “pertinent keyword” edit is completed 8. When user clicks “finish,” a list of “pertinent keywords” is generated 9. The list also shows page number in the manuscript where the “keywords” are located 9a. Duplicated “keywords” are highlighted on the list 9b. This gives the user an opportunity to change the “pertinent keywords,” 9c e.g., it isn't sufficient to repeat the word “museum” many times or to write generic descriptions such as a “Paris museum;” the user needs to be specific, e.g. the “Louvre” museum. This action gives the user an opportunity to micro-manage keywords with specifics while maintaining the page number and integrity of the database. Therefore, specific descriptions are updated and retagged, and/or a user may opt to leave the text as is. If text is left as is, right clicking the text will restore the normal text without tags. Clicking on each repetitive word on the list 9d, automatically returns the user to the page where the word is located in the manuscript so it can be removed by double clicking 7a, 9c. When completed, user clicks “Finish” 10. A revised “pertinent keyword” list is generated 10a. Once overall satisfaction has been achieved, user clicks “Metadata” 11. A final description of all revised metadata that has been entered, plus the list of “tags,” is generated 11a. A record of the metadata may be physically printed 11b. If satisfied, user clicks “Send” 12, activating genre recognition 4a. One link may be to one or more Interactive (digital) or traditional ad agencies specializing in specific genres. Another link is sent to the software provider. Another link is sent to the publisher if an author is under contract to that publisher 12b. Self-published authors are the ones who activated Send Button and already have the file 12c.

The next steps involve one or more ad agencies. Publishers/authors' status and genre selected in 4a), plus keywords, influences an ad agency(ies) “ad content” selection and database merge in terms of the following 13: (1) On a scale of 1-5, celebrity authors are a “5” whereas an 1^{st} time, unknown author [most likely self-published] would be a 1; 95% of authors are between 1-3; (2) Buy-rates are determined accordingly; (3) Ad buys are due and payable on 15-day billing cycles because books have a long shelf life and the custom-redirect 2D barcodes are “printed” in books; (4) Contracts with ad agencies specify content providers must provide “informative/educational” (versus overt) Web links; see 22a)/22b) or be rejected in the final stages of testing the URLs that have been provided and prior to generating the custom-redirect 2D barcodes. The whole purpose of this invention is to make it easy for readers to learn more if they want to clarify an author's text. This feature delivers immeasurable value from a single printed book.

Ad agency(ies) merge “pertinent keywords” from the book's list with that from the content providers' 14. Best matches include 14a: Webinars, videos, podcasts or whitepapers as indicated in the metadata in the database 4a. Data merge generates a complete URL for each content provider 14b. URL is added to the original “pertinent metadata and keyword list” 14c. Gross ad-buy revenue is automatically generated for a book based on the publishers/authors' self-proclaimed status ranging from 1 to 5 14c, 4a. Excluding celebrity authors, ranked 5, 2D code insertions (ad-buys) are currently established at $100 thru $300 for POD (print on demand=predominately self-published authors) and $400 per ad-buy for traditional publishers and well known authors (self-published or not); ad-buys are renewable annually and can be changed out at that time 15a. Rank 5's rate unknown since some celebrities might attract thousands of dollars per custom-redirect 2D barcode insertions.

An ad agency disseminates revised “pertinent metadata and keyword list” to the software provider 16. Ad agency(ies) bill advertisers using their respective internal billing procedures/systems 16a and deducts the appropriate amount from the content providers' accounts @ 100% ad buy rate (assumed procedure) 16b. The participating ad agencies pay the software provider's invoices in 2-week billing cycles 16c.

The following steps involve the software provider. Upon receipt of revised “pertinent metadata and keyword list” 16), an invoice, less 15% for the ad agencies commission, is generated and electronically transmitted to ad agency for payment 17, 16c. Based on “pertinent metadata and keyword list,” a custom-redirect 2D barcode is generated for the respective publishers and/or authors 18. Each codes is tested for accuracy and compliance to the software provider's high standards for informational content; although content providers may use logos to identify their content on their respective websites 18a. Once approved, custom-redirect 2D barcodes are then generated for the author's/publisher's manuscript 18b. Approved codes are transmitted together with the “pertinent metadata and keyword list” to publishers and/or authors 19. Disbursement is made to the publishers or authors on 2-week billing cycles and before the book goes to print 20. Self-publishers are paid less than traditional publishers; the excess which is a 10% difference is set aside for the software provider's educational grant-making activities 20a. The software provider also maintains ongoing updates of its databases, upgrading, quality control and customer services 21.

The next steps may involve one or more authors, writers, publishers, and/or editors as the user. The user inserts the custom-redirect 2D barcodes in the manuscript during its final edit according to prior “pertinent metadata and keyword list,” and before book goes to print 22. Should the user reject any of the content provider's submissions for inclusion, the user clicks on the original keyword removing it; all of their internal records are adjusted 22a. The user then transmits any adjustments or code deletions to software provider 22b.

The software generates adjustment(s) notice and corrects internal records 23, and transmits final adjustments for a specific book title with its “pertinent keyword list and metadata” to an ad agency; final includes adjustments, code deletions with URLs 23a. An ad agency adjusts records using publisher enhanced software and internal recordkeeping system 24. One of the functions of the present invention is to allow a reader to scan a custom-redirect 2D barcode with a web-enabled electronic device or smartphone.

The foregoing illustrations, embodiments, and examples are used in this disclosure to describe and convey the details of the present invention. These illustrations, embodiments, and examples do not represent an exhaustive list of embodiments and examples of the present invention. One of ordinary skill in the art may recognize that the described invention may be facilitated by different means, may use different configurations, and/or may contain more or less sets, processes, or components than explicitly listed in this disclosure. Furthermore, the directional indicators (arrows and lines) used in the figures are not meant to limit the direction in which an interaction or transfer occurs. It is contemplated and foreseeable that interactions may occur in a direct not expressly illustrated in the figures of this disclosure.

I claim:

1-20. (canceled)

21. A method comprising:
(i) scanning at least one document for relevant content; and
(ii) generating at least one custom-redirect 2D barcode from said relevant content.

22. A method as in claim 21, further comprising:
(i) inserting said at least one custom-redirect 2D barcode among content of said document.

23. A method as claimed in claim 22, further comprising:
(i) converting said relevant content into metadata;
(ii) exporting said metadata to at least one third-party; and
(iii)generating at least one uniform resource locater associated to said relevant content.

24. A method as in claim 23, wherein uniform resource locator links to a remote content source and said multimedia contains at least one video, webinar, podcast, computer enhanced demonstration, pictorial demonstration, or a whitepaper.

25. A method as in claim 24, further comprising:
(i) editing of relevant content by a user; and
(ii) generating a summary of said relevant content, wherein summary is linked to relevant content in said document.

26. A method as in claim 25, further comprising:
(i) transmitting said at least one custom-redirect 2D barcode to said user . (ii) inserting at least one custom-redirect 2D barcode in close proximity to the pre-selected relevant content in said document.

27. A method as claimed in claim 26, further comprising:
(i) identifying said relevant content by a user, wherein said user answers a list of related questions and selects content within said document.

28. A method as in claim 27, further comprising:
(i) Receipt of said metadata by said at least one third-party, matching
(ii) said metadata to related electronic content; and
(iii)Merging said metadata with said at least one third-party's database, wherein said metadata includes at least one uniform resource locator.

29. A method as in claim 28, further comprising:
(i) transmitting said metadata to at least one specified third-party, where at least one third-party coalesces the metadata with complementary informational content that is hosted by at least one remote electronic device by said at least one third-party.

30. A method as in claim 29, wherein said at least one third-party is an ad agency that determines the appropriate multimedia for relevant content from among said at least one third-party's clients.

31. A method as in claim 30, further comprising:
(i) matching and merging the metadata with said at least one third-party's database.

32. A method as claimed in claim 31, further comprising:
(i) submitting said document prior to scanning for said relevant content, wherein a user is required to register with a software provider and use said software provider's software, and wherein said relevant content is limited to a percentage of the size of said document.

33. A method as in claim 32, wherein said document is limited to a certain size and said user is assigned an account identifier, and where said at least one code is tested for accuracy.

34. A method as in claim 33, wherein at least one of the uniform resource locaters selected by said user is added to the metadata and utilized by at least one third-party for billing purposes.

35. A method as in claim 34, wherein said at least one third-party simultaneously disseminates a revised metadata to a software provider and said at least one third-party bills at least one client.

36. A method as in claim 35, wherein said at least one third-party deducts a client's accounts at one hundred percent for all ad buy rates and said software automatically invoices said at least one third-party based upon the metadata received in two-week billing cycles, and wherein a fifteen percent commission is automatically deducted from said buy-rate.

37. A method as in claim 36, further comprising:
(i) Adjusting relevant content by said user by selecting a custom-redirect two-dimensional code from the document content and adjusting all records, wherein, said software automatically updates its internal recordkeeping system and sends an adjustment notice to at least one third-party.

38. A method comprising:
(i) Scanning said at least one custom-redirect two-dimensional barcode; and
(ii) Linking from the scanning device to the multimedia, wherein said multimedia is varied informative content that has been associated with a document.

39. A system comprising:
(i) At least one scanning software program;
(ii) At least one database; and
(iii) At least one code generator.

40. A system as in claim 39, further comprising:
(i) A user interface; and
(ii) Wherein, said software program includes management and operational processes for invoicing, tracking, and payments keyed to the pertinent metadata.
